(19) United States
(12) Patent Application Publication
(10) Pub. No.: US 2024/0139663 A1
(43) Pub. Date: May 2, 2024

(54) METHOD OF MANUFACTURING A POROUS FILTER FOR DEGASSING

(71) Applicant: CSK INC., Yongin-si, Gyeonggi-do (KR)

(72) Inventor: GeunWoo Park, Yongin-si, Gyeonggi-do (KR)

(21) Appl. No.: 18/550,839

(22) PCT Filed: Mar. 14, 2022
(86) PCT No.: PCT/IB2022/052266

§ 371 Date: Sep. 15, 2023

(30) Foreign Application Priority Data
Mar. 19, 2021 (KR) 10-2021-0035585

(51) Int. Cl. B01D 39/16; B01D 19/00

(52) U.S. Cl. CPC B01D 39/1692; B01D 19/0031; B01D 2239/10; B01D 2239/1216

(57) ABSTRACT

A method of manufacturing a porous filter includes a step of preparing a first porous filter having first micropores, a step of increasing the size of the first micropores by stretching while heating the first porous filter, a step of maintaining the increased size of the first micropores by sucking a liquid into the increased first micropores, and a step of forming a second porous filter having second micropores larger than the first micropores by evaporating the liquid.

### CROSS-REFERENCE OF RELATED APPLICATION

This application is a Section 371 National Stage Application of International Application No. PCT/IB2022/052266, filed Mar. 14, 2022, and published as WO 2022/195444 A1 on Sep. 22, 2022, the content of which is hereby incorporated by reference in its entirety and which claims priority of Korean Application No. 10-2021-0035585, filed Mar. 19, 2021.

### FIELD

The present invention relates to a method for manufacturing a porous filter for degassing, and more particularly, to a method for manufacturing a porous filter for degassing capable of adjusting the size of micropores.

### BACKGROUND

In the semiconductor process, as is widely known, chemical vapor deposition (CVD) and atomic layer deposition (ALD) entail the process of injecting vaporized precursor and reactants together or separately injecting the vaporized precursor.

Broadly, the methods for moving and supplying these precursors to the reactor can be classified as a liquid delivery method, which directly controls the liquid flow rate of the precursor, and a bubbler supply method, which controls the vaporized flow rate of the precursor stored in the precursor canister. The method of transporting the precursor to the reaction site is an important variable in the deposition process.

Among them, the bubbling supply method is a supply method suitable for transporting a liquid precursor having a low vapor pressure, and uses a gas such as He, Ar, N2, which is a high purity inert gas, as a carrier gas.

However, precursors with organic metal framework characteristics may be dissolved in the carrier gas during transport by the bubbling supply method, causing defects in the chemical deposition process. Accordingly, in the process of supplying the precursor, a process of filtering the carrier gas dissolved in the spheroid using a degasser is involved.

Accordingly, in the prior art, He gas has been used as a carrier gas, and a porous filter made of PFA material has been used to degas it. However, due to factors such as an increase in the price of He gas, it is necessary to use Ar gas, which is another inert gas, as a carrier gas, and development of a suitable porous filter has been required.

The discussion above is merely provided for general background information and is not intended to be used as an aid in determining the scope of the claimed subject matter. The claimed subject matter is not limited to implementations that solve any or all disadvantages noted in the background.

### SUMMARY

An object of the present invention is to provide a method for manufacturing a porous filter for degassing that can expand the size of the micropores of a porous filter for degassing that has been used in the past.

In order to achieve the above-stated object, the present invention provides a method of manufacturing a porous filter for degassing wherein, in a method for manufacturing a porous filter that uses the difference in molecular size between a first material and a second material, from a mixture comprising the first material, and the second material having a smaller molecular size than the first material, to filter the second material, the method comprises a step of preparing a first porous filter having first micropores, a step of increasing the size of the first micropores by stretching while heating the first porous filter, a step of maintaining the increased size of the first micropores by sucking a liquid into the increased first micropores, and a step of forming a second porous filter having second micropores larger than the first micropores by evaporating the liquid.

According to the present invention, the following effects are obtained.

First, since the size of the micropores of the porous filter for degassing can be easily adjusted, a porous filter suitable for filtering gases having various molecular sizes can be easily manufactured.

Second, by manufacturing a porous filter with micropores of various sizes by physically expanding the pore size of the existing porous filter, it has the advantage of being universally applicable to the porous filter manufacturing method used in various technical fields.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a view for explaining a process of filtering a carrier gas in a bubble supply method for supplying a known precursor.

FIG. 2 is a flowchart illustrating a method of manufacturing a porous filter for degassing according to an embodiment of the present invention.

FIG. 3 is a view showing the micropores of the conventional porous filter made of PFA material and the micropores of the porous filter made of PFA material manufactured by the method of FIG. 2.

FIG. 4 is a view showing experimental conditions of a filtering test of a porous filter made of PFA material manufactured by the method of FIG. 2.

FIG. 5 is a schematic diagram of a filtering test apparatus of a porous filter made of PFA material manufactured by the method of FIG. 2.

FIGS. 6 to 9 are the test results of the porous filter made of PFA material manufactured by the method of FIG. 2 shown through the test process of FIGS. 4 and 5.

### DETAILED DESCRIPTION

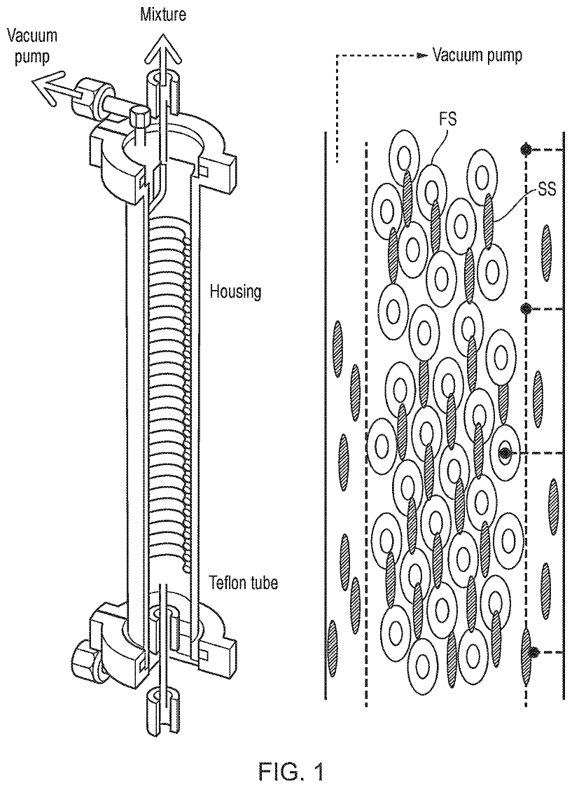

FIG. 1 is a view showing a process of filtering a carrier gas in a bubbling supply method for supplying a known precursor.

Referring to FIG. 1, in a state in which a microporous filter is installed, consisting of a Teflon tube in a housing that provides a transport path of a mixture (Chemical flow) comprising a first material (FS) comprising a precursor and a second material (SS) as a carrier gas for transporting the precursor, the process of filtering a carrier gas in a bubbler supply method of supplying a known precursor comprises a process wherein, by sucking the second material (SS), which is a carrier gas, with a vacuum pump (Degasser Vacuum), the second material (SS), which is a carrier gas having a small molecular size, is filtered through a Teflon tube, which is a microporous filter, and degassed.

Specifically, fine pores are formed in the porous filter, wherein molecules larger than the pore size, such as precursors such as TEOS (TetraEthOxy Silane, 9.54 Å), TEB (TriEthyl Borate, 8.44 Å), and TEPO (TriEthyl PhOsphate, 9.52 Å), cannot be discharged out of the porous pulper, while carrier gases He (2.18 Å), Ar (3.64 Å) and N2 (3.75 Å) have smaller molecular weights and can be discharged. Here, the molecular size of the gas He is the smallest and the degassing efficiency is the highest.

Therefore, in order to improve the degassing efficiency of other carrier gases such as Ar and N2 to the level of the degassing efficiency of He gas, it is necessary to expand the size of the micropores of the porous filter in proportion to the molecular size of the carrier gas.

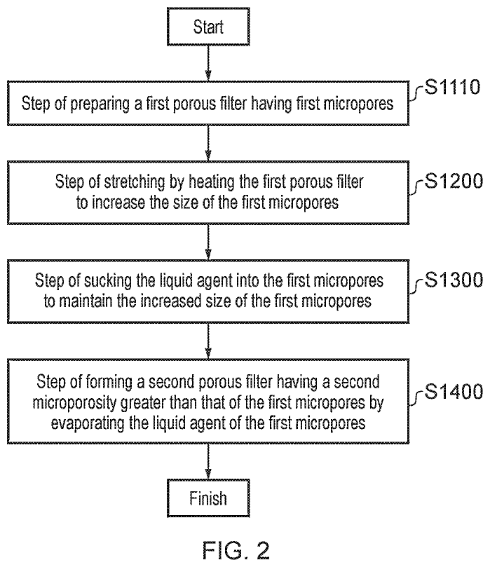

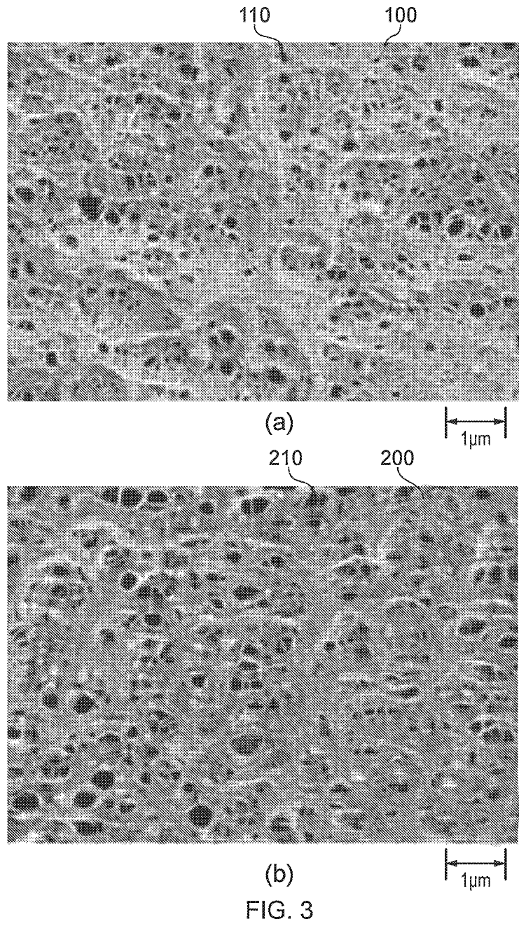

Hereinafter, a method of manufacturing a porous filter for degassing according to an embodiment of the present invention will be described in detail with reference to FIGS. 2 and 3.

Referring to FIG. 2, in the manufacturing process of the porous filter for degassing according to an embodiment of the present invention, first, a first porous filter 100 having first micropores is prepared (S1100). At this time, the first porous filter 100 is formed of a polymer material of PFA (Perfluoroalkoxy); however, the technical idea of the present invention is not limited thereto, and of course, it may be a fluororesin comprising any one of FEP (Fluoroethylenepropylene), PVDF (Polyvinylidene fluoride), and PTFE (Polytetrafluoroethylene).

Here, in brief about the physical properties of the PFA fluororesin, it has a porous, flexible molecular structure, it is easy to heat and reprocess, and has the advantage that there is little effect from impurities due to the generation of particles to chemicals during processing.

Other physical properties such as heat resistance, chemical resistance, and non-reactivity of the PFA resin are replaced with known contents.

Next, the first porous filter 100 is stretched while heating to increase the size of the first micropores 110 (S1200). At this time, during the process of increasing the size of the first micropores 110, the heating process is a process of heating the first porous filter 100 to a glass transition temperature; the stretching process is either one of a process of stretching the first porous filter 100 in one axial direction in the width direction or the height direction, or a process of stretching the first porous filter 100 in two axial directions in the width direction and the height direction. Here, the process of stretching in the uniaxial direction (S1220) may be a process of stretching in the height direction in a state in which the width direction is fixed, or stretching in the width direction in a state in which the height direction is fixed; the first porous filter 100 and the second porous filter 200 to be described later may be manufactured in the form of a sheet.

As described above, after expanding the first micropores 110 of the first porous filter 100, the liquid is sucked into the first micropores 110 whose size is increased, so that the increased size of the first micropores 110 is maintained. (S1300) At this time, during the process of maintaining the size of the first micropores 110 (S1300), the liquid is a liquid that has been rendered into a liquefied state, that has been maintained in a gaseous state at room temperature, and the first porous filter 100 is cooled in a state in which the first porous filter 100 fills the increased micropores.

After that, when the size of the first micropores 110 is cooled and maintained (S1300), by evaporating the liquid in the first micropores 110, the second porous filter 200 having second micropores 210 larger than the first micropores 110 is formed (S1400). At this time, the liquid is vaporized at room temperature and escapes from the first micropores 110, so that, as shown in FIG. 3, a second porous filter (FIG. 3B) having second micropores larger in size than the first micropores (FIG. 3A) of the first porous filter is manufactured. Herein, the liquid described above is preferably liquid nitrogen.

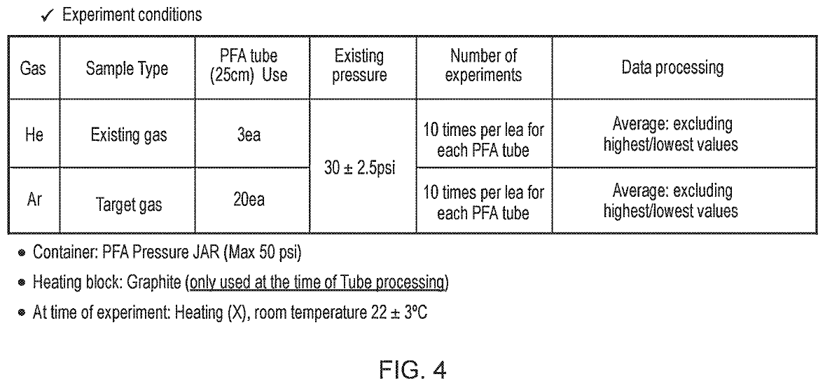

Hereinafter, the performance of the porous filter for degassing manufactured according to an embodiment of the present invention will be described in detail with reference to FIGS. 4 to 9. However, details that overlap the above-described details will be omitted or abbreviated.

FIG. 4 shows the conditions for degassing a plurality of times the second material (SS) whose carrier gas is He gas from the first material (FS) comprising a spherical body through the first porous filter (100) having the first micropores (110), and the conditions for degassing a plurality of times the second material (SS) whose carrier gas is Ar gas from the first material (FS) comprising a precursor through the second porous filter (200) having the second micropores (210). The experiment using the He gas was repeated every 10 times with 3 first porous filters 100, and the experiment with the Ar gas was repeated with 10 second porous filters 200 per 10 times. At this time, as the result data, the average data of the state excluding the highest/lowest values of the figures repeated 10 times were used.

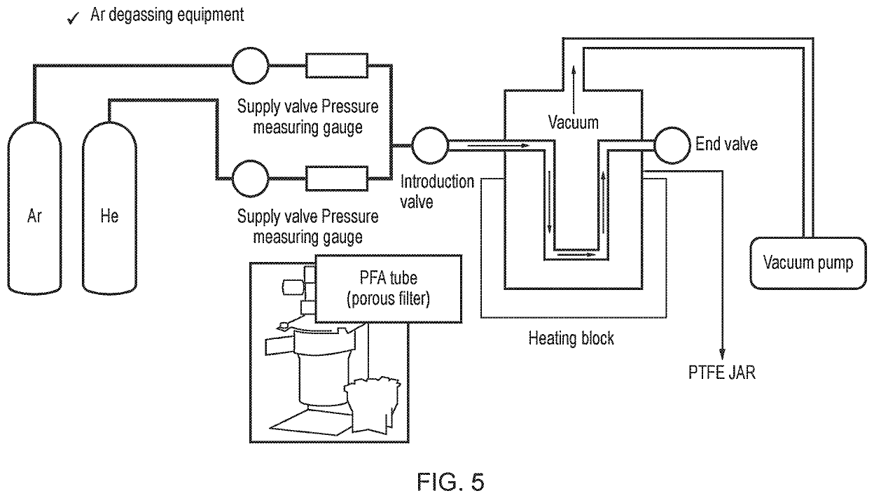

In addition, the configurations of the tester for the performance test are schematically disclosed in FIG. 5. The tester was built as one device with the same configuration; the experiment was conducted by selectively supplying the mixture supplied from the receiving tank, comprising each precursor whose carrier gas is He gas and Ar gas, through the opening and closing of the supply valve, and selectively replacing the first porous filter 100 and the second porous filter 200 disposed in the transport path. At this time, the transport path was heated to an appropriate temperature by the heating block and maintained, and suction pressure was applied to each porous filter of the transport path by a vacuum pump to filter each carrier gas.

The result data according to the experiment were calculated in the following manner with each carrier gas being supplied at a constant pressure from the receiving tank, when each carrier gas was degassed by the suction pressure of the vacuum pump through the porous filters 100 and 200, the pressure loss rate of the pressure gauge installed in the conveying path or the injection path was converted into the degassing rate.

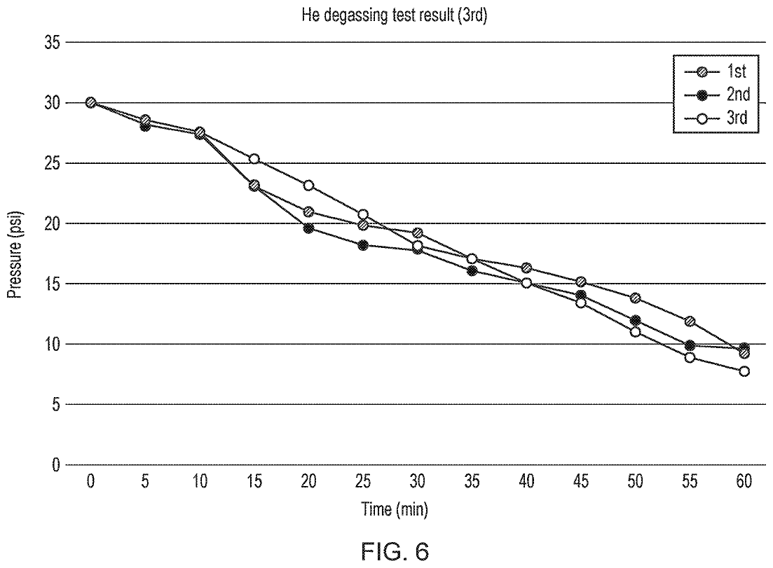

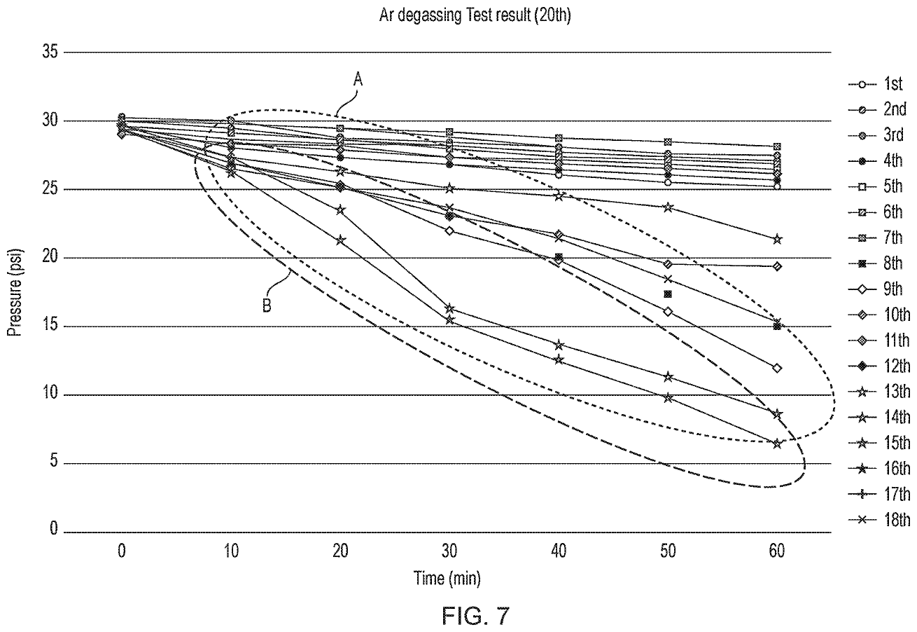

FIGS. 6 and 7 show average values tested a plurality of times in the process of degassing He gas (refer to FIG. 6) and average values tested a plurality of times in the process of degassing Ar gas (refer to FIG. 7). Here, the x-axis diagram of the graph indicates the amount of change over time, and the y-axis diagram indicates the amount of change in pressure over time.

As contrasted with FIGS. 6 and 7, the experimental results data shown in the process of degassing Ar gas and degassing He gas appear in a generally similar pattern (part A); some of them were found to have approximate result values (part B).

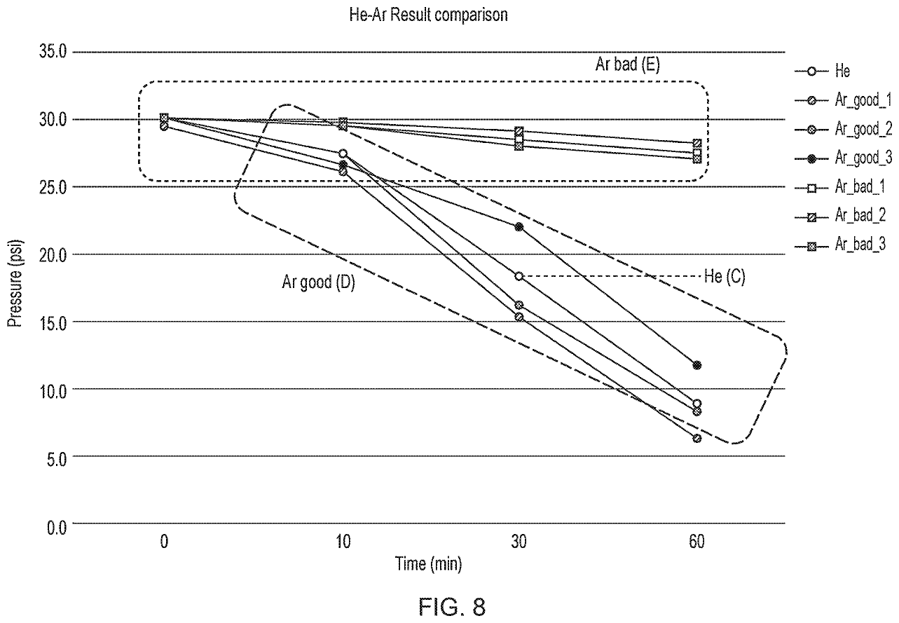

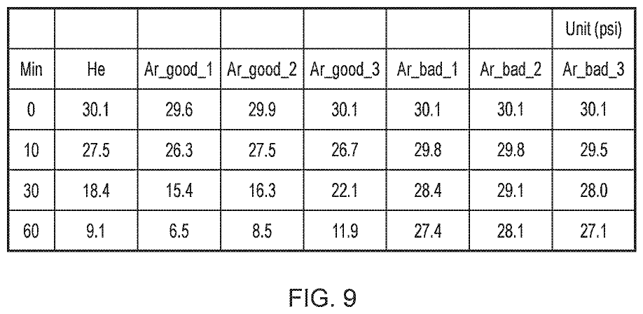

FIGS. 8 and 9 show the pressure changes according to the experiment involving the second porous filters 200 of defective products with uneven pores during the manufacturing process and good products with evenly formed pores.

As shown in FIGS. 8 and 9, the experimental data (part C) of good products shows a pattern approximate to the experimental data (part D) using He as the carrier gas, while the experimental data (part E) of the defective products shows little change in pressure.

Accordingly, the degassing efficiency for the precursor mixture in which the carrier gas of the second porous filter 200 manufactured according to the method for manufacturing a porous filter for degassing according to an embodiment of the present invention is Ar seems to make it possible to replace the degassing efficiency for the precursor mixture in which the carrier gas of the first porous filter 100 is He.

The present invention has been described with reference to the embodiments shown in the drawings, which are only exemplary; it will be understood by those skilled in the art that various modifications and equivalent other embodiments are possible therefrom. Accordingly, the true technical protection scope of the present invention should be determined by the technical spirit of the appended claims.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A method of manufacturing a porous filter for degassing wherein, in a method for manufacturing a porous filter that uses the difference in molecular size between a first material and a second material, from a mixture comprising the first material, and the second material having a smaller molecular size than the first material, to filter the second material, the method comprises a step of preparing a first porous filter having first micropores, a step of increasing the size of the first micropores by stretching while heating the first porous filter, a step of maintaining the increased size of the first micropores by sucking a liquid into the increased first micropores, and a step of forming a second porous filter having second micropores larger than the first micropores by evaporating the liquid.

2. The method of manufacturing a porous filter for degassing according to claim 1, wherein the first porous filter is a fluororesin comprising at least one of Perfluoroalkoxy (PFA), Fluoroethylenepropylene (FEP), Polyvinyliclene fluoride (PVDF), and Polytetrafluoroethylene (PTFE).

3. The method of manufacturing a porous filter for degassing according to claim 1, wherein in the step of preparing the first porous filter, the first porous filter is made of a polymer material, and in the step of increasing the size of the micropores of the first porous filter, the heating serves to heat the first porous filter to a glass transition temperature.

4. The method of manufacturing a porous filter for degassing according to claim 1, wherein in the step of increasing the size of the first micropores of the first porous filter, the stretching, the stretching stretches first porous filter in the uniaxial direction of the width direction or the height direction, or stretches the first porous filter in the biaxial direction of the width direction and the height direction.

5. The method of manufacturing a porous filter for degassing according to claim 1, wherein in the step of maintaining the increased size of the first micropores of the first porous filter, the liquid is a liquid that has been rendered into a liquefied state, that has been maintained in a gaseous state at room temperature, and the first porous filter is cooled in a state in which the size of the first porous filter is filled with increased micropores.

6. The method of manufacturing a porous filter for degassing according to claim 5, wherein in the step of forming a second porous filter having the second micropores, the liquid vaporizes at room temperature, and exits from the first micropores having an increased size.

7. The method of manufacturing a porous filter for degassing according to claim 1, wherein the first material is a material containing a precursor.

8. The method of manufacturing a porous filter for degassing according to claim 1, wherein the second material is He, Ar or N2.

9. The method of manufacturing a porous filter for degassing according to claim 1, wherein the liquid is liquid nitrogen.

10. The method of manufacturing a porous filter for degassing according to claim 1, wherein the porous filter has a sheet shape.
